(19) United States
(12) Patent Application Publication
(10) Pub. No.: US 2012/0056727 A1
(43) Pub. Date: Mar. 8, 2012

(54) EQUIPMENT STATUS CONTROLLING METHOD AND EQUIPMENT

(76) Inventor: LIPING ZHU, SAN JOSE, CA (US)

(21) Appl. No.: 13/225,515

(22) Filed: Sep. 5, 2011

Related U.S. Application Data
(60) Provisional application No. 61/380,317, filed on Sep. 6, 2010.

(30) Foreign Application Priority Data
Nov. 22, 2010 (CN) 201010558063.0

(51) Int. Cl. G05B 11/01

(52) U.S. Cl. 340/12.5

(57) ABSTRACT

The present invention discloses an equipment status controlling method and equipment. The method comprises arranging a corresponding wireless communicating part for at least one component of a piece of equipment, the wireless communicating part comprising a storage unit for storing component information and a transmitting unit for transmitting the component information based on wireless signal; receiving the wireless signal transmitted by the wireless communicating part and parsing the wireless signal to obtain the component information. The equipment status controlling method and equipment provided by the invention obtain the status of a component in the equipment correctly and easily by arranging wireless communicating part on the components. Arranging the wireless communicating part and reading the wireless signal can be realized easily, which substantially will not affect the existing work of the equipment and can obtain the status of the components without disassembling or replacing the components. As for large-scale equipment, status of each component can be obtained by arranging a corresponding wireless communicating part for each component so as to do corresponding maintenance and repair processing work in time. The operation is to be realized at a low cost.

### CROSS-REFERENCE TO RELATED APPLICATIONS

This application claims priority of provisional application No. 61/380,317, filed on Sep. 6, 2010, and Chinese Patent Application No. 201010558063.0 filed on Nov. 22, 2010, which are hereby incorporated by reference in their entirety.

### FIELD OF THE TECHNOLOGY

The embodiments of the invention relate to equipment monitoring technology, and more particularly to an equipment status controlling method and equipment.

### BACKGROUND

With the development of science and technology, the structure of existing equipment becomes increasingly complex. For example, generally, a piece of equipment, such as a plane, a rocket, a medical device or a vehicle etc., is a large system which consists of thousands of hardware and further the hardware may be installed with various kinds of software inside.

Hardware, software or firmware which is a combination of software and hardware may need to be improved or updated in aspects such as function or technology used. Or the hardware, software or firmware may have to be discarded due to aging or damage. The hardware, the software and the firmware are collectively called components. During the maintenance and repair of equipment, it is required to know the status of each component in order to decide which components should be improved for updating or discarded for being replaced and which components can be kept for use.

However, the cost and the difficulty are increased during the maintenance and repair of the equipment because of the complexity of the structure thereof. Each component may have its own status, service life and update cycle, which are different from another one. Close relationship may exist among components, for example, compatibility exists between the software and hardware or among different software. Those factors bring difficulty for the maintenance and repair of the equipment. It is apparently that disassembling the equipment to check components one by one will consume large cost, and in fact it is hard to operate.

### SUMMARY

The embodiments of the present invention provide an equipment status controlling method and a kind of equipment so as to obtain the status information of each component in a piece of equipment easily and correctly and decrease the cost of maintenance and repair.

The embodiment of the present invention provides an equipment status controlling method comprising:

arranging a corresponding wireless communicating part for at least one component of a piece of equipment, the wireless communicating part comprising a storage unit for storing component information and a transmitting unit for transmitting the component information based on wireless signal;

receiving the wireless signal transmitted by the wireless communicating part and parsing the wireless signal to obtain the component information.

The embodiment of the present invention further provides a kind of equipment comprising a plurality components, the plurality components comprising hardware, software and/or firmware, wherein the equipment further comprising:

one or more than one wireless communicating parts, each wireless communicating part is arranged to correspond to at least one component, the wireless communicating part comprising a storage unit for storing component information and a transmitting unit for transmitting the component information based on wireless signal.

The equipment status controlling method and the equipment provided by the present invention obtain the status of a component in the equipment correctly and easily by arranging wireless communicating part on the components. Arranging the wireless communicating part and reading the wireless signal can be realized easily, which substantially will not affect the existing work of the equipment and can obtain the status of the components without disassembling or replacing the components. As for a piece of large-scale equipment, status of each component can be obtained by arranging a corresponding wireless communicating part for each component so as to do corresponding maintenance and repair processing work in time. The operation is easy to be realized at a low cost.

### BRIEF DESCRIPTION OF THE DRAWINGS

FIG. 1 is a flow diagram of an equipment status controlling method provided by Embodiment 1 of the present invention;

FIG. 2 is a flow diagram of an equipment status controlling method provided by Embodiment 2 of the present invention; and

FIG. 3 is a block diagram of a piece of equipment provided by Embodiment 4 of the present invention.

### DETAILED DESCRIPTION

In order to make the purpose and technology and advantages of the embodiments provided by the invention clearer, a further detailed description of embodiments of the present invention is given by reference to accompanying drawings. Apparently, the described embodiments are part of the embodiments of the invention, not all of the embodiments. It is obvious that from this teaching the skilled person in the art may find other embodiments to realize the teaching of the present invention without applying additional inventive activities. These embodiments are still under the scope of the present claims.

### Embodiment 1

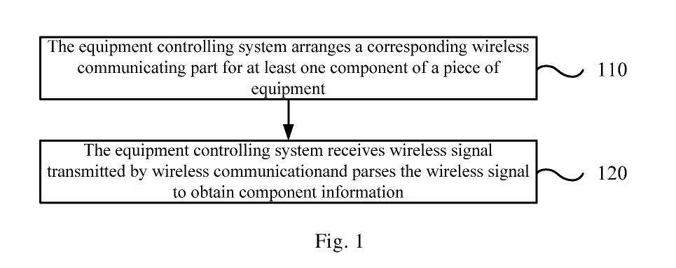

FIG. 1 is a flow diagram of an equipment status controlling method provided by Embodiment 1 of the present invention, the method is adaptable for a piece of equipment comprising a plurality of components and for equipment in various fields, particularly for a large-scale equipment such as a vehicle, a rocket, a plane, and a piece of semiconductor equipment, a piece of medical equipment or manufacture equipment, etc.

Among components by which the equipment is formed, at least one component is provided with a wireless communicating part, for example, components which are important and/or need to be replaced frequently are provided with corresponding wireless communicating parts, or each component of the equipment is provided with a corresponding wireless communicating part. The definition of the component herein refers to hardware, software or firmware, etc. and further can be an assembly formed by the combination of several hardware, software and/or firmware. The wireless communicating part can be any device with wireless signal transmitting function and storage unit, for example, Bluetooth, zigbee and WiFi, etc. Preferably, Radio Frequency Identification (RFID) part is used as radio frequency identifying part.

The equipment status controlling method provided by the embodiment is implemented for the equipment with the structure described above and the specific implementer can be an equipment controlling system for controlling equipment status. The definition of the equipment controlling system can be an assembly of tools for various monitoring, repair, maintenance and installing and the participation of operators. The method specifically comprises the following steps:

Step 110, the equipment controlling system arranges a corresponding wireless communicating part for at least one component of the equipment, the wireless communicating part comprises a storage unit for storing component information and a transmitting unit for transmitting component information based on wireless signal;

Specifically, the above step 110 can be operated by an operator or an installed device. The embodiment is described in detail by taking an example of an RFID part as a wireless communicating part and the wireless signal is radio frequency signal transmitted by the transmitting unit of the RFID part based on radio frequency. The component provided with RFID part can be hardware, software or firmware and the RFID part is arranged to correspond to the component device. The RFID part can be arranged directly on a hardware entity or at other positions, which has a corresponding relationship with a specified component.

Step 120, the equipment controlling system receives wireless signal transmitted by wireless communication, e.g., the radio frequency signal transmitted by the RFID part, and parses the wireless signal to obtain component information.

As for the situation where an RFID part is adopted, the above step 120 can be specifically performed by a radio frequency receiving device and a data parsing device, and the component information is obtained by receiving and parsing the radio frequency signal. There are many ways for receiving radio frequency signal, for example:

As for some active RFID systems, RFID tag/part can transmit signals at any time according to the program, or transmit signals according to the command of a radio frequency reader. In this case, the outer radio frequency receiving device consists of a receiving module. As for some passive or semi-passive RFID systems, a piece of equipment with the RFID tag/part transmits signals only upon the control command of a ratio frequency receiver of a piece of control equipment. Many ways for receiving radio frequency signals are suitable for the technical solution of the embodiment of the present invention.

According to the above technical solution of the embodiment, the status of the components in the equipment can be obtained easily and correctly by arranging wireless communicating part on the component. As for the RF technology, the arrangement of the RFID part and reading the radio frequency signal can be realized easily, which substantially will not affect the existing work of the equipment and can obtain the status of components without disassembling and replacing the components. As for a piece of large-scale equipment, status of a component can be obtained by arranging corresponding wireless communicating part for the component so as to do corresponding maintenance and repair processing work in time. The operation is easy to be realized at a low cost.

The technical solution of the embodiment further comprises that, before or while arranging wireless communicating part on at least one component of the equipment, the equipment controlling system writes component information of the component into the storage unit of the wireless communicating part. That is, before arranging the wireless communicating part, component information corresponding to the component is written into the storage unit by a computer or wireless signal. The component information can also be written into the storage unit simultaneously when installing the wireless communicating part.

The way for writing the component information is not limited to what is described above. Preferably, the component information of the component can still be written in the storage unit of the wireless communicating part based on the wireless signal after arranging the wireless communicating part on at least one of the component of the equipment. The technology of writing the component information, which permits to write or update the information in wireless way after completing the assembling of the equipment, can update information when necessary and need not disassemble the equipment as well, and substantially will not affect the normal working of the equipment. In addition, the writing technology is simple and convenient at a low operating cost.

In a broad sense, the component information of the embodiment can be thought to be any information associated with the component. Typically, the component information comprises component version information, component compatibility information and/or component association information.

The component version information can comprise such information as the manufacturer name, version number, model number, manufacture date, etc. of the component, which reflects basic status and initial information of the component. For example, the manufacture date of hardware can be used for judging the service life of the hardware, and it is not required to check the component substantially and periodically for determining whether the component is invalid.

The component compatibility information can comprise the information indicating whether the component is compatible with other components, can comprise the version information and the version information of hardware and/or software which supports the software, and further can comprise version information of other software which is compatible with the software, etc. The component compatible information can be used for correctly determining the compatibility of the component to avoid the misusing of software or hardware. In case that hardware B need cooperate with software A to work, and software A can cooperate with hardware B1 and hardware C but can not cooperate with hardware C1, all of the compatible hardware B1 and hardware C and the incompatible hardware C1 should be recorded in the RFID part of software A. The component compatible information can be used in many ways, for example, when a piece of software needs to be updated, determining whether other hardware or software needs to be replaced as well by checking the component compatible information of the software or determining whether the software can not be updated to new version due to the limitation of other hardware or software.

The component association information can relate to the information among the components which are associated with each other. For example, the component association information of a component can comprise names of other components which are associated with the component directly in capability. In case that hardware B needs to associate with software A to work, the association relationship between the hardware B and the software A should be recorded in the RFID part of hardware B and the RFID part of the software A respectively. Hence, when maintaining and repairing a component, other associated components could be considered.

The component information recorded in the wireless communicating part is not limited to the information as above described, and can be any information which is associated with the component and is required as reference. For example, the information can further comprise component position information of a component in the equipment, e.g. a motor is arranged at the fore part or rear part in an vehicle; component structure information of a component for indicating the smaller parts by which the component is formed, e.g. the motor assembly is made up by the cylinder, axis of rotation and crankshaft and connecting rod etc; component function information indicating basic function of the component, checking history information and repairing history information of the component.

In the embodiment, after the equipment controlling system receiving wireless signal and parsing the wireless signal to obtain component information, the component information can be used in many scenes. For example, 1) replacing an old component, i.e. determining whether the old component is invalid and should be checked or replaced according to the component information; 2) updating software, i.e. when a component has a new version, determining whether a piece of new software can be used to replace an old software by reading the component information and whether the problems such as compatibility and association exist; 3) intellectual maintenance, i.e. reading the component information of all of the components to check and maintain the equipment periodically and determine whether a component need to be updated; 4) failure alarm, i.e. after obtaining the component information by parsing the wireless signal, comparing the alarm threshold value in the component information with the operating status information, and making an alarm when the operating status information reaches the alarm threshold value.

In the failure alarm function, alarm threshold value could be predetermined in the component information, when the operating status information reaches the alarm threshold value, an alarm signal is generated for making an alarm. For example, the threshold value of service life is set to be 1 year, and the alarm signal is generated when the result for the current time of reading the component information minus the manufacture date of the component is 1 year.

### Embodiment 2

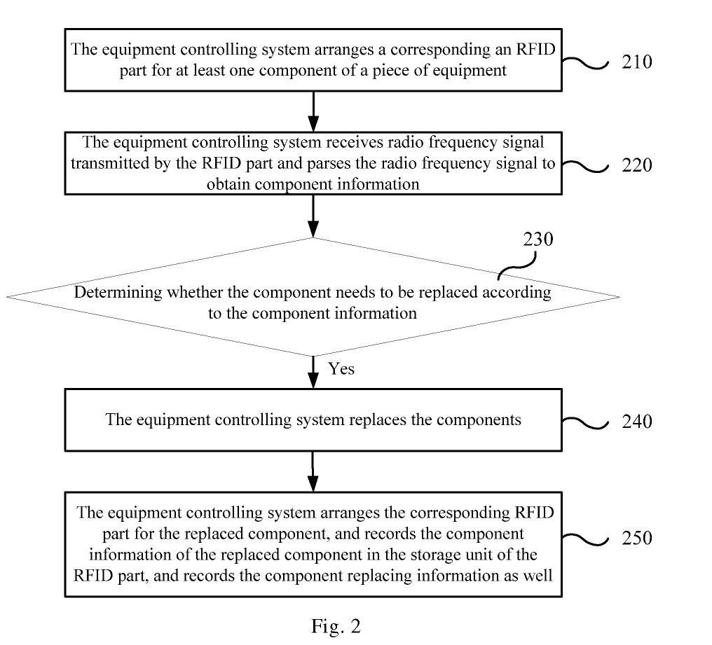

FIG. 2 is a flow diagram of an equipment status controlling method provided by Embodiment 2 of the present invention, the difference between this embodiment and the Embodiment 1 is that Embodiment 1 provides a solution for obtaining component information in time so as to obtain the status of the component easily and correctly. This embodiment further adds an operation for replacing component, i.e. after parsing the wireless signal to obtain component information, this embodiment further comprises replacing a component when the equipment controlling system determines that the component needs to be replaced according to the component information; arranging a corresponding wireless communicating part for the replaced component and recording the component information of the replaced component in the storage unit of the wireless communicating part, and recording the component replacing information as well. The technical solution is beneficial to decrease the difficulty in updating and repairing the equipment.

Taking an RFID part for example, specifically, the method of the embodiment comprises the following steps:

Step 210, the equipment controlling system arranges a corresponding RFID part for at least one component;

Step 220, the equipment controlling system receives radio frequency signal transmitted from the RFID part and parsing the radio frequency signal to obtain component information;

Step 230, the equipment controlling system determines whether the component needs to be replaced according to the component information, if the answer is yes, go to step 240; otherwise, no operating needs to be done;

In above step 230, determining whether the component needs to be replaced depends on whether the service life threshold value is reached or whether an advanced component for updating the existing component etc, it can also be replaced if the component has compatibility problem with the replaced components when other components are replaced.

Step 240, the equipment controlling system replaces the components, which can be that an operator or other device disassembles and installs hardware, and can also be the operation of loading and unloading software, etc.

Step 250, the equipment controlling system arranges the corresponding RFID part for the replaced component, and records the component information of the replaced component in the storage unit of the RFID part, and records the component replacing information as well.

In above step 250, the replaced component can be arranged with new RFID part or uses the RFID part of the existing component to arrange the RFID part to correspond to the replaced component. The RFID part of the replaced component stores not only the regular component information but also further component replacing information. The component replacing information can comprise any information that needs be recorded for reference, such as replacing time, replacing place and information of the component being replaced etc.

The above solution not only can easily obtain the information related to a component, but also can easily and correctly track the replacing history of the component as the basis for maintaining and repairing of the equipment, which will decrease the difficulty in maintenance and repair of the equipment. For some industries, the basis for repairing the equipment is regulated by the policy.

### Embodiment 3

The equipment status controlling method provided by Embodiment 3, which is based on Embodiment 1 or Embodiment 2, further comprises that the equipment collects component information by a sensor arranged on the equipment and stores the component information in the storage unit.

The technical solution further collects component information by the sensor such that the equipment controlling system can obtain richer component information. It should be understood that the information which can be collected by the sensor is a kind of component information. The component information stored in the storage unit can only comprise the information collected by the sensor or can also comprise the component information with other contents.

In practical application, some components may lose their reliability and usability because of wear and tear or accident of the equipment. Preferably, the sensor can collect such dynamically changing component information, there are many kinds of such component information, for example, collecting the component information by the sensor arranged on the equipment can comprise that the equipment controlling system takes the rotation speed collected by the rotation speed sensor arranged on the equipment as component information; and/or the equipment controlling system takes the temperature collected by the temperature sensor arranged on the equipment as component information.

Taking a vehicle for example to describe, the sensor can collect references such as rotation speed, accumulated rotation turns, weekly the highest history temperature of the cooling every week and temperature of shell of a motor etc. as the component information. The sensor can be the sensor already existing in the vehicle or can be a newly installed one.

The step of collecting component information by the sensor arranged on the equipment and storing the component information in the storage unit can comprise,

collecting operation references by the sensor arranged on the equipment, and when determining that the operation reference reaches a predetermined threshold value, storing the operation reference and the collecting time as the component information in the storing unit; or

collecting operation references periodically by the sensor arranged on the equipment and statically processing the periodically collected operation references to store as the component information in the storage unit, where statically processing the periodically collected operation references can be calculating mean value or obtaining the highest value, etc.

The data collected by the sensor can be written in the RFID part in real time, periodically, triggered externally or triggered by some event generated by the sensor. For example, for a plane, in order to assure the safety of the plane in working, it may take the operating references of key components which are collected according predetermined period as component information to be stored, and then check respective operating references when checking the plane. Comparing with checking or disassembling hardware in the prior art, the above way of checking saves time and labor cost apparently.

The failure alarm function introduced above can combine the sensor, i.e. comparing the alarm threshold value in the component information with the operating status information collected by the sensor and making an alarm when the operating status information reaches the alarm threshold value.

In the technical solution of the embodiment, the RFID part and the sensor are used to establish a component information network of the equipment, which not only can store static component information but also collect dynamic component information in real time, that is, the RFID part and the sensor are used to monitor and track the status of the component in real-time, which can reflect the status of the component totally and correctly, it is beneficial for decreasing difficulty in maintenance and repair and cost, increasing the efficiency of maintenance and repair and avoiding hidden danger threaten safety as well.

### Embodiment 4

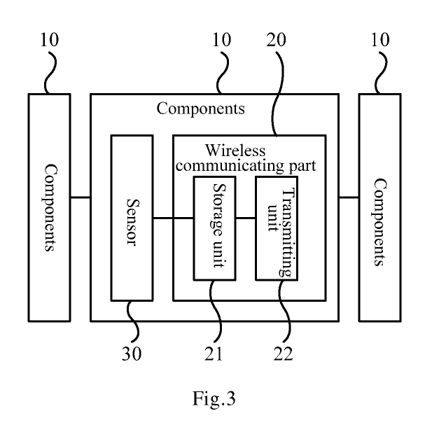

FIG. 3 is a block diagram of a piece of equipment provided by Embodiment 4 of the present invention. The equipment comprises a plurality of components 10 which can be in form of hardware, software and/or firmware, etc. In addition, the equipment further comprises one or more than one wireless communicating part 20, each wireless communicating part 20 is arranged to correspond to at least one component 10, the wireless communicating part 20 comprises a storage unit 21 for storing component information and a transmitting unit 22 for transmitting component information based on wireless signal.

Preferably, the wireless communicating part is a RFID part, which transmitting radio frequency signal based on radio frequency as wireless signal.

Based on above the technical solution, the equipment further can comprise one or more sensor 30, each sensor 30 is arranged to correspond to at least one component 10 for collecting component information and storing the component information in the storage unit 21.

The sensor can collect dynamic information of the components of the equipment for knowing the operating status of the equipment. The sensor can be specifically a rotation speed sensor or temperature sensor, etc.

The equipment provided by the embodiment can store all kinds of information relating to the components by RFID part, and the information can be read by the equipment controlling system via wireless way easily. The specific operating method can be implemented by performing any equipment controlling methods provided by the embodiments, the RFID part and the sensor can have the function units with which perform corresponding function described above and every function unit can be implemented by software and/or hardware. The sensor can check the dynamic operating status of the components and use the RFID part to transmit dynamic component information as references for maintaining and repairing the equipment.

The equipment provided by the invention obtains the status of the components in the equipment correctly and easily by arranging wireless communicating part on the components. Arranging the wireless communicating part and reading the wireless signal can be realized easily, which substantially will not affect the exiting work of the equipment and can obtain components status without disassembling or replacing components. As for large-scale equipment, status of each component can be obtained by arranging a corresponding wireless communicating part for each component so as to do corresponding maintenance and repair processing work in time. The operation is easy to be realized with low cost.

Those skilled in the art should understand that the some or all of the steps in the embodiment of the method above can be implemented by hardware related to instructions of a program, the program can be stored in a storage medium media which is readable for a computer; when the program is executed, the steps in the embodiment of the method above are executed; the storage medium media including medium, such as ROM, RAM, magnetic disk or compact disk, for storing program code.

Finally, it should be understood that the above embodiments are only used to explain, but not to limit the technical solution of the present invention. Though the preferred embodiments are described above in details, those skilled in the art should understand that that various modifications, changes or equivalent replacements can be made by those skilled in the art without departing from the scope of the present invention and covered in the claims of the present invention.

What is claimed is:

1. An equipment status controlling method comprising:
arranging a corresponding wireless communicating part for at least one component of a piece of equipment, the wireless communicating part comprising a storage unit for storing component information and a transmitting unit for transmitting the component information based on wireless signal;
receiving the wireless signal transmitted by the wireless communicating part and parsing the wireless signal to obtain the component information.

2. The equipment status controlling method of claim 1, wherein the wireless communicating part is a radio frequency identifying part, and the wireless signal is radio frequency signal transmitted by the transmitting unit of radio frequency identifying part based on the radio frequency.

3. The equipment status controlling method of claim 2, wherein the method further comprising before or while arranging wireless communicating part on at least one component of the equipment, writing the component information of the component in the storage unit of the wireless communicating part.

4. The equipment status controlling method of claim 2, wherein after arranging a corresponding wireless communicating part on at least one component of the equipment, the method further comprising writing the component information of the component in the storage unit of the wireless communicating part based on wireless signal.

5. The equipment status controlling method of claim 1, wherein the component is hardware, software or firmware, and the component information comprising component version information, component compatibility information and/or component association information.

6. The equipment status controlling method of claim 2, wherein the component is hardware, software or firmware, and the component information comprising component version information, component compatibility information and/or component association information.

7. The equipment status controlling method of claim 3, wherein the component is hardware, software or firmware, and the component information comprising component version information, component compatibility information and/or component association information.

8. The equipment status controlling method of claim 4, wherein the component is hardware, software or firmware, and the component information comprising component version information, component compatibility information and/or component association information.

9. The equipment status controlling method of claim 1, wherein, after parsing the wireless signal to obtain the component information, the method further comprising:
replacing the component when determining the component should be replaced according to the component information;
arranging a corresponding wireless communicating part for the replaced component, and recording the component information of the replaced component in the storage unit of the wireless communicating part, and recording the component replacing information.

10. The equipment status controlling method of claim 2, wherein, after parsing the wireless signal to obtain the component information, the method further comprising:
replacing the component when determining the component should be replaced according to the component information;
arranging a corresponding wireless communicating part for the replaced component, and recording the component information of the replaced component in the storage unit of the wireless communicating part, and recording the component replacing information.

11. The equipment status controlling method of claim 3, wherein, after parsing the wireless signal to obtain the component information, the method further comprising:
replacing the component when determining the component should be replaced according to the component information;
arranging a corresponding wireless communicating part for the replaced component, and recording the component information of the replaced component in the storage unit of the wireless communicating part, and recording the component replacing information.

12. The equipment status controlling method of claim 4, wherein, after parsing the wireless signal to obtain the component information, the method further comprising:
replacing the component when determining the component should be replaced according to the component information;
arranging a corresponding wireless communicating part for the replaced component, and recording the component information of the replaced component in the storage unit of the wireless communicating part, and recording the component replacing information.

13. The equipment status controlling method of claim 1, wherein after parsing the wireless signal to obtain the component information, the method further comprising:
comparing the alarm threshold value in the component information with operating status information and making an alarm when the operating status information reaches the alarm threshold value.

14. The equipment status controlling method of claim 2, wherein after parsing the wireless signal to obtain the component information, the method further comprising:
comparing the alarm threshold value in the component information with operating status information and making an alarm when the operating status information reaches the alarm threshold value.

15. The equipment status controlling method of claim 3, wherein after parsing the wireless signal to obtain the component information, the method further comprising:
comparing the alarm threshold value in the component information with operating status information and making an alarm when the operating status information reaches the alarm threshold value.

16. The equipment status controlling method of claim 4, wherein after parsing the wireless signal to obtain the component information, the method further comprising:
comparing the alarm threshold value in the component information with operating status information and making an alarm when the operating status information reaches the alarm threshold value.

17. The equipment status controlling method of claim 1, wherein the method further comprising:
collecting component information by a sensor arranged on the equipment and storing the component information in the storage unit.

18. The equipment status controlling method of claim 2, wherein the method further comprising:
collecting component information by a sensor arranged on the equipment and storing the component information in the storage unit.

19. The equipment status controlling method of claim 3, wherein the method further comprising:
collecting component information by a sensor arranged on the equipment and storing the component information in the storage unit.

20. The equipment status controlling method of claim 4, wherein the method further comprising:
collecting component information by a sensor arranged on the equipment and storing the component information in the storage unit.

21. The equipment status controlling method of claim 17, wherein collecting component information by a sensor arranged on the equipment comprising:
taking rotation speed collected by a rotation speed sensor arranged on the equipment as the component information; and/or
taking temperature collected by a temperature sensor arranged on the equipment as the component information.

22. The equipment status controlling method of claim 18, wherein collecting component information by a sensor arranged on the equipment comprising:
taking rotation speed collected by a rotation speed sensor arranged on the equipment as the component information; and/or
taking temperature collected by a temperature sensor arranged on the equipment as the component information.

23. The equipment status controlling method of claim 19, wherein collecting component information by a sensor arranged on the equipment comprising:
taking rotation speed collected by a rotation speed sensor arranged on the equipment as the component information; and/or
taking temperature collected by a temperature sensor arranged on the equipment as the component information.

24. The equipment status controlling method of claim 20, wherein collecting component information by a sensor arranged on the equipment comprising:
taking rotation speed collected by a rotation speed sensor arranged on the equipment as the component information; and/or
taking temperature collected by a temperature sensor arranged on the equipment as the component information.

25. The equipment status controlling method of claim 17, wherein collecting component information by a sensor arranged on the equipment and storing the component information in the storage unit comprising:
collecting operating reference by the sensor arranged on the equipment, and storing the operating reference and collecting time as the component information in the storage in storage unit when determining that the operating reference reaches a predetermined threshold value; or
collecting operating reference periodically by the sensor arranged on the equipment and statically processing the periodically collected operation references to store as the component information in the storage unit.

26. The equipment status controlling method of claim 18, wherein collecting component information by a sensor arranged on the equipment and storing the component information in the storage unit comprising:
collecting operating reference by the sensor arranged on the equipment, and storing the operating reference and collecting time as the component information in the storage in storage unit when determining that the operating reference reaches a predetermined threshold value; or
collecting operating reference periodically by the sensor arranged on the equipment and statically processing the periodically collected operation references to store as the component information in the storage unit.

27. The equipment status controlling method of claim 19, wherein collecting component information by a sensor arranged on the equipment and storing the component information in the storage unit comprising:
collecting operating reference by the sensor arranged on the equipment, and storing the operating reference and collecting time as the component information in the storage in storage unit when determining that the operating reference reaches a predetermined threshold value; or
collecting operating reference periodically by the sensor arranged on the equipment and statically processing the periodically collected operation references to store as the component information in the storage unit.

28. The equipment status controlling method of claim 20, wherein collecting component information by a sensor arranged on the equipment and storing the component information in the storage unit comprising:
collecting operating reference by the sensor arranged on the equipment, and storing the operating reference and collecting time as the component information in the storage in storage unit when determining that the operating reference reaches a predetermined threshold value; or
collecting operating reference periodically by the sensor arranged on the equipment and statically processing the periodically collected operation references to store as the component information in the storage unit.

29. A piece of equipment comprising a plurality components, the plurality components comprising hardware, software and/or firmware, wherein the equipment further comprising:
one or more than one wireless communicating parts, each wireless communicating part is arranged to correspond to at least one component, the wireless communicating part comprises a storage unit for storing component information and a transmitting unit for transmitting the component information based on wireless signal.

30. The equipment of claim 29, wherein the wireless communicating part is a radio frequency identifying part.

31. The equipment of claim 29, wherein the equipment further comprising:
one or more than one sensor, and each sensor is arranged to correspond to at least one of the components for collecting component information and storing the component information in the storage unit.

32. The equipment of claim 30, wherein the equipment further comprising:
one or more than one sensor, and each sensor is arranged to correspond to at least one of the components for collecting component information and storing the component information in the storage unit.
